(19) United States
(12) Patent Application Publication
(10) Pub. No.: US 2026/0023565 A1
(43) Pub. Date: Jan. 22, 2026

(54) ADAPTIVE MEMORY ADDRESS COMPUTATION BASED ON TENSOR DIMENSIONS

(71) Applicant: Tenstorrent USA, Inc., Austin, TX (US)

(72) Inventors: Rakesh Shaji Lal, Hamilton (CA); Syed Gilani, Markham (CA)

(21) Appl. No.: 19/212,655

(22) Filed: May 19, 2025

Related U.S. Application Data
(60) Provisional application No. 63/671,776, filed on Jul. 16, 2024.

(51) Int. Cl. G06F 9/34; G06F 9/30; G06F 9/38

(52) U.S. Cl. CPC G06F 9/34; G06F 9/30036; G06F 9/3867

(57) ABSTRACT

Systems and methods for adaptive memory address computations based on tensor dimensions are disclosed herein. A system for generating a memory address for a tensor stored in a data tile in memory may include an instruction line with an unpack instruction identifying a location in the tensor, a first address logic pipeline outputting a first address output, a fast address logic pipeline outputting a fast address output, and a control logic circuit. The control logic circuit routes one and only one of the first address output or the fast address output to be used as the memory address to access the tensor. This system enables efficient and adaptive memory address computation based on tensor dimensions, allowing for optimized performance when processing tensors with common dimensions while maintaining flexibility for handling various tensor sizes.

### CROSS-REFERENCE TO RELATED APPLICATIONS

This application claims the benefit of U.S. Provisional Patent Application No. 63/671,776 filed Jul. 16, 2024, which is incorporated by reference herein in its entirety for all purposes.

### BACKGROUND

Logic pipelines that compute physical addresses for data structures in a memory are essential components in computer architecture, particularly in the context of memory management and data retrieval. These pipelines typically involve several stages, each performing specific functions to translate a virtual address into a physical address. For example, a CPU could generate a virtual address, which is then processed by a Memory Management Unit (MMU), and then the MMU uses a combination of page tables and translation lookaside buffers (TLBs) to map the virtual address to a physical address. Page tables, which are often hierarchical, store the mappings between virtual and physical addresses, while TLBs cache recent translations to expedite the process. The pipeline ensures that these operations are carried out efficiently, handling page faults and permissions checks to maintain system stability and security. The result is a physical address that can be used to access the corresponding data structure in the memory, facilitating seamless data management and retrieval in modern computing systems.

Once the physical address of a data structure is determined through the initial translation process, an additional step may be conducted which involves generating the physical memory address of a specific data element within a larger data structure. This task is handled by another set of logic pipelines that leverage the known base address of the larger data structure and the offset of the target element within it. The offset is typically calculated based on the data structure's layout and the position of the desired element, often requiring knowledge of the data structure's type, such as an array, linked list, or tree. For arrays, the offset is derived from the index of the element multiplied by the size of each element. In the case of more complex structures like linked lists or trees, the pipeline must follow pointers or references that dictate the location of each element. These pipelines may include address generation units (AGUs) that perform arithmetic operations to add the base address to the calculated offset, producing the final physical address of the specific data element. This process ensures precise and efficient access to data elements within larger structures, enabling effective memory utilization and performance optimization in software applications.

### SUMMARY

This application discloses systems and methods for adaptive memory address computation based on tensor dimensions. The systems include a first address logic pipeline and a fast address logic pipeline that receive an unpack instruction identifying a location of an entry in a tensor stored in a data tile in memory. A control logic circuit routes either the first address output or the fast address output to be used as the memory address to access the tensor, with the fast address logic pipeline being optimized for tensors having certain common dimensions.

The systems further incorporate configuration registers storing tensor dimensions and tile section address logic pipelines. A first tile section address logic pipeline and a fast tile section address logic pipeline receive the tensor dimension and output tile section address outputs. Another control logic circuit selectively routes one of these outputs for use in generating the memory address. This allows for efficient computation of addresses for different sections within data tiles, such as exponent and mantissa sections for floating point data types.

Control logic circuits in the disclosed systems utilize multiplexers to adaptively select between outputs from standard and fast logic pipelines based on tensor dimensions. When tensor dimensions match common dimensions, such as powers of two, the fast pipelines can be utilized to improve address computation speed. This adaptive approach enables the systems to efficiently handle tensors with varying dimensions while maintaining optimized performance for common cases.

In specific embodiments of the invention, a system for generating a memory address for a tensor stored in a memory is provided. The tensor is stored in a data tile in the memory. The system comprises an instruction line with an unpack instruction. The unpack instruction identifies a location in the tensor. The system also comprises a first address logic pipeline that is coupled to the instruction line and that outputs a first address output and a fast address logic pipeline that is coupled to the instruction line and that outputs a fast address output. The fast address logic pipeline is faster than the first address logic pipeline. The system also comprises a control logic circuit that routes either the first address output or the fast address output to be used as the memory address to access the tensor in the memory.

In specific embodiments of the invention, a system for generating a memory address for a tensor stored in a memory is provided. The tensor is stored in a data tile in the memory. The system comprises: a configuration register storing a tensor dimension, a first tile section address logic pipeline that receives the tensor dimension and outputs a first tile section address output based on the tensor dimension, and a fast tile section address logic pipeline that receives the tensor dimension and outputs a fast tile section address output. The fast tile section address logic pipeline is faster than the first tile section address logic pipeline. The system also comprises a control logic circuit that routes one and only one of: (i) the first tile section address output for use in generating the memory address; and (ii) the fast tile section address output for use in generating the memory address.

In specific embodiments of the invention, a method for generating a memory address for a tensor is provided. The method comprises: storing the tensor in a data tile in a memory, determining a tensor dimension of the tensor, and selecting either a first address logic pipeline or a fast address logic pipeline based on the tensor dimension. The fast address logic pipeline is faster than the first address logic pipeline for a set of tensor dimensions. The method also comprises inputting, into the selected address logic pipeline, an unpack instruction. The method also comprises outputting, from the selected address logic pipeline and based in the unpack instruction, an address output. The method also comprises generating the memory address based on the address output.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of a memory which stores one or more portions of a tensor in accordance with specific embodiments of the inventions disclosed herein.

FIG. 2 provides an example of a data structure in accordance with specific embodiments of the inventions disclosed herein.

FIG. 3 provides an example of a system for producing an unpack start address for an unpack instruction in accordance with specific embodiments of the inventions disclosed herein.

FIG. 4 provides an example of a more complex system for producing an unpack start address for an unpack instruction in accordance with specific embodiments of the inventions disclosed herein.

FIG. 5 provides an example of a flowchart for determining a memory address in accordance with specific embodiments of the inventions disclosed herein.

FIG. 6 provides an example of a tensor with dimensions that are powers of two in accordance with specific embodiments of the inventions disclosed herein.

FIG. 7 provides an example of a method for generating a memory address for a tensor in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for memory address generation in computer processing units in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

This application discloses systems and methods for adaptive memory address computation based on tensor dimensions. The systems may include a first address logic pipeline and a fast address logic pipeline that may receive an unpack instruction identifying a location of an entry in a tensor stored in a data tile in memory. A control logic circuit may route either the first address output or the fast address output to be used as the memory address to access the tensor, with the fast address logic pipeline being optimized for tensors having certain common dimensions.

The systems may further incorporate configuration registers storing tensor dimensions and tile section address logic pipelines. A first tile section address logic pipeline and a fast tile section address logic pipeline may receive the tensor dimension and output tile section address outputs. Another control logic circuit may selectively route one of these outputs for use in generating the memory address. This allows for efficient computation of addresses for different sections within data tiles, such as exponent and mantissa sections for floating point data types.

Control logic circuits in the disclosed systems may utilize multiplexers to adaptively select between outputs from standard and fast logic pipelines based on tensor dimensions. When tensor dimensions match common dimensions, such as powers of two, the fast pipelines can be utilized to improve address computation speed. This adaptive approach enables the systems to efficiently handle tensors with varying dimensions while maintaining optimized performance for common cases.

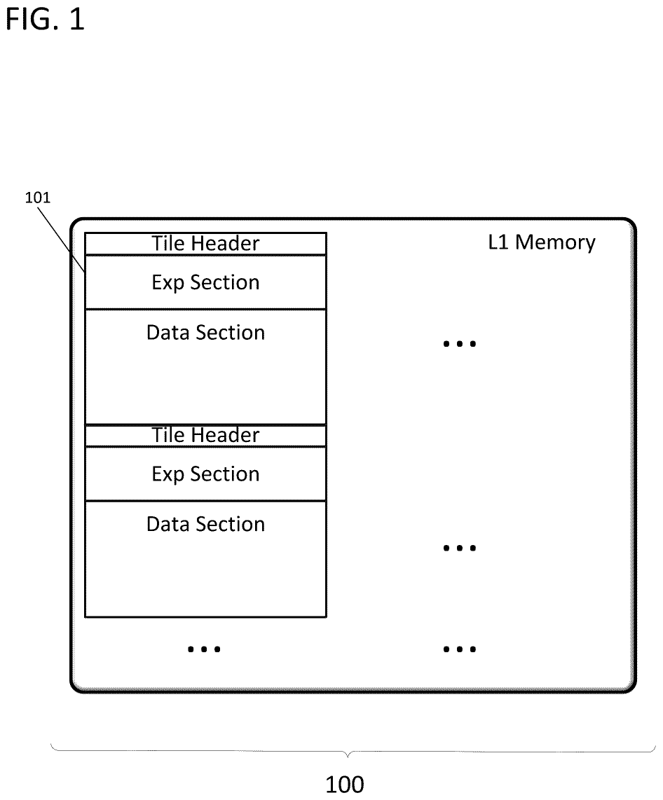

FIG. 1 illustrates a memory 100, in this case the L1 cache memory of a processor, which stores one or more portions of a tensor in accordance with specific embodiments of the inventions disclosed herein. The tensors can be used in a machine learning or artificial intelligence applications, graphics processing applications, cryptographic applications, or other computational applications using large data structures. The portions of the tensor can be stored in large data structures such as tile 101 in memory 100. Tile 101 may include a tile header, an exponent section, and a data section. The tiles can store portions of a tensor. However, in specific embodiments, an entire tensor can be stored in a tile. The tiles can include headers and different sections based on the number of data elements stored in the tile and the data type (e.g., Boolean, integer, floating point, etc.) of the data elements stored in the tile. The data elements can represent individual entries in the tensor (e.g., in a 2×1 tensor the data elements could represent the two entries of the tensor). Using approaches disclosed herein, logic pipelines can more efficiently compute the physical addresses in memory (e.g., a physical address in the L1 cache of FIG. 1) of specific data elements within a larger data structure such as the address of an entry in a tensor stored in the data tiles illustrated in FIG. 1. For example, a logic pipeline could compute a physical address for an unpack instruction that identified a portion of a tensor in a data tile that needed to be accessed for a computation.

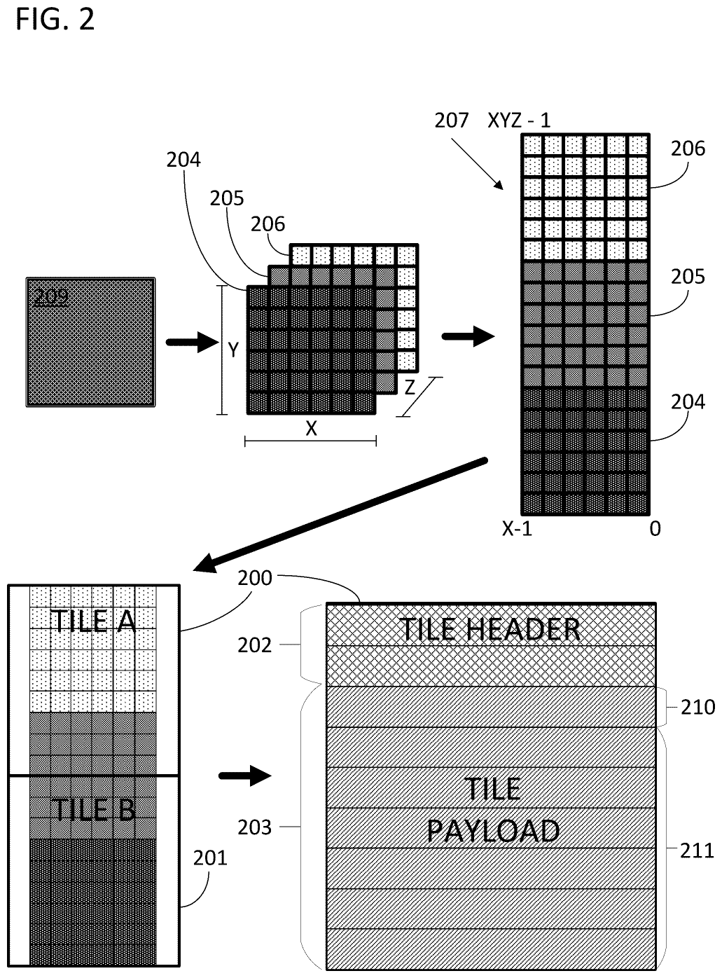

FIG. 2 provides an illustration of a data structure in accordance with specific embodiments disclosed herein. In this approach, the data structure is a data tile. In FIG. 2, the data structure is represented by two independent instantiations thereof in the form of data tile A 200 and data tile B 201. The detailed view of data tile A 200 shows that the tile is formed by a repeating structure of rows with an identical number of columns in each row. The detailed view also shows tile header 202 consisting of two of such rows and data tile payload 203 consisting of 7 rows.

The payload of data tile A 200 can store computational data in the form of multiple entries of one or more tensors. In the illustrated case, the entries of the tensor have a floating-point data type such that each entry includes a mantissa and an exponent. Furthermore, data tile payload 203 includes a first section 210 in which the exponents are stored and a second section 211 in which the mantissas are stored. The entries of the data tile therefore do not directly correspond in sequence with the entries of the tensor as the values of the tensor are each represented by two entries in the data tile.

The illustration in FIG. 2 shows the relationship between the variable-level, the data structure-level (e.g., tile-level), and memory address-level of a computational system in accordance with specific embodiments disclosed herein. The memory-address-level can be the lowest level known to the computational system and can include an addressing system which allows the computational system to request specific portions of the tensors that are being used by the computational system to conduct a computation. For example, the memory-address-level could be used to access the entries of the tile as they are stored in memory (e.g., a mantissa value for one of the entries of the tensor as stored in section 211). The memory-address-level can utilize physical memory addresses which refer to specific physical addresses at which data elements are stored. The data structure-level can utilize data structure entry addresses which refer to specific data entries within the data structure. The variable-level can utilize variable entry addresses which refer to specific entries of the variable (e.g., specific entries in a matrix).

FIG. 2 illustrates tensor 209 which is at the variable-level of the computational system. Tensor 209 could be an input tensor to a layer in a CNN which will be used in a convolution operation during the execution of a directed graph to which it is a part. In the illustrated case, tensor 209 is a three-dimensional tensor which can be represented by “z” two-dimensional matrices 204, 205, and 206. In this illustrated simplified case, the dimension of tensor 209 in the “Z” direction is three which is why 3 two-dimensional matrices are needed. However, the approaches disclosed here are not limited to three-dimensional tensors and can operate with tensors whose higher-level dimensions have domains that are orders of magnitude larger than three. The size of the tensor in the X and Y domains are 6 and 6 respectively as represented by each of matrices 204-206. In a practical application, these numbers could each range into the millions or billions.

The squares in matrices 204-206 represent individual entries in the tensor which can be stored as individual data elements in a data structure and can be independently addressed in a memory. The values could be represented in memory using data elements with specific data types and precision levels (e.g. 16-b floating point). The data elements of data tile A 200 could have much higher precision levels and be alternative data types. The individual data values of the tensor can be addressed using a standard cartesian coordinate system. For a three-dimensional tensor, the coordinates would be (x, y, z) with x ranging from 0 to X−1, y ranging from 0 to Y−1, and z ranging from 0 to Z−1.

The memory address-level space will likely be a one, two, or three-dimensional space based on the hardware of the memory the data structures will be stored in. A typical planar memory system such as a traditional flash memory will be two-dimensional. A stack-based memory is one-dimensional. A modern three-dimensional memory cube is three-dimensional. However, tensors in a directed graph can have dimensionality of 4-dimensions, 5-dimensions, and more. As such, a translation can reduce the dimensionality from the variable-level space to the memory address-level space.

FIG. 2 provides an illustration of translating a three-dimensional tensor (e.g., at the variable-level space) into the address space of a two-dimensional physical or virtual memory (e.g., at the memory address-level space) and storing the tensor in a customized data structure within that memory space. The process involves essentially laying the three matrices that consist of the z-planes of tensor 209 end-to-head as shown in view 207 and addressing them row-by-row from bottom to top. Obtaining an address of a data element in the memory-address-space given an address of the data element in the graph-space would thereby involve the translation: Address (x, y, z)=x+X*y+X*Y*z. Where “X”, “Y”, and “Z” are the size of the domains of the three-dimensions of the tensor, and (x, y, z) are the coordinates of the data element in the graph-space. The same approach can be applied to tensors of higher dimensionality with the equation being extended by another factor in accordance with this pattern. For example, in the case of a four-dimensional tensor, the equation becomes Address (x, y, z, w)=x+X*y+X*Y*z+X*Y*Z*w. Using this equation, a translation can be found between the variable-level and memory address-level of the system. This translation can be used to obtain specific data from tensor 209 when executing the directed graph to which tensor 209 is a part. The translation can be the first step in conducting a random access of data in tensor 209.

The combinatorial logic pipelines disclosed herein can be tasked with converting a location in the variable-level or data-structure-level (e.g., data tile level) into an address at the memory-level. For example, the combinatorial logic pipelines can take in an address of an entry in a tensor and provide a physical memory address for that tensor in a memory. To translate all the way from the variable-level to the memory-level, the system may need to know where the data structures (e.g., tiles) are stored in memory and which variables are stored in which data structures. Determining the physical memory address of an entry in a tensor can thereby include a first computation to find the physical memory address for a data structure (e.g., tile) or portion thereof, and then a second computation to find the offset for the specific entry in the tensor.

FIG. 2 also provides an illustration of how data tile A 200 and data tile B 201 specified in the variable-level of the computational system relate to the memory-address-space. As illustrated, the two tiles are used to store the directed graph data associated with the single tensor 209. As explained previously, a single tensor could alternatively be stored in a single data structure (i.e., all of tensor 209 could alternatively have been stored in data tile A 200 if the size of data tile A 200 had been set to a larger value). The variable data can be stored in the data structures in compressed or uncompressed form.

If the computational elements of a processing core request specific data in variable-space, the request can be in the form of a variable-space location (e.g., an (x, y, z) location). In certain approaches, the (x, y, z) variable-space location will be provided to a data management block that can compress tensor data from, and decompress tensor data into, data structures on the fly. In the illustrated case, this could involve a data management block receiving the variable-space location (0, 0, 0), decompressing data tile B 201, obtaining the data at address (0, 0, 0), and providing the data. The data management block could then compress any result of computations using that data back into memory once the computational units had conducted the necessary operations. The operation of accessing and decompressing data entries in a given tensor could be specified by an unpack instruction which referred to the data entries in the variable-space. A combinatorial logic pipeline could then convert the location of the data entries in the variable-space in the unpack instruction into one or more addresses in the memory-address space.

In specific embodiments of the invention, a system is provided for accessing variables stored in memory. The variables can be a vector or can be multidimensional and can include multiple entries. The variables can be tensors. The variables can be stored in a data structure in the memory. The variables can be stored in data tiles in the memory. The memory can take on various forms such as main memory, caches, buffers, and other memories. The memory can be random access memory. The memory can be two dimensional or three-dimensional physical memory. The system can be a system for generating an address for a tensor stored in a memory wherein the tensor is stored in a data tile in the memory.

In specific embodiments of the invention, the systems disclosed herein can include instruction lines that receive instructions that must operate on specific variables or specific entries of those variables such that their addresses must be derived in order to first access the data from memory. The instruction can identify an entry in a variable. The instruction can identify an address in a tensor. For example, the instruction line could include an unpack instruction, provided for purposes of allowing the system to derive an address of a specific variable or specific entry of that variable in memory. The instruction line can provide the identity of an entry in a variable (e.g., a location in a tensor) to a logic pipeline which can be used to derive information for physically accessing that entry from memory (e.g., the physical memory address of the entry or portions of the data structure in which the entry is stored).

In specific embodiments of the invention, the systems disclosed herein can include a first address logic pipeline and a fast address logic pipeline. The address logic pipelines can be programmed to convert a location in a data structure or in a variable (i.e., in the variable-space or the data-structure-space) into a physical address in memory (i.e., in the physical-memory-address-space). The first address logic pipeline can produce a first address output in response to the location in the data structure or variable. The fast address logic pipeline can produce a fast address output in response to the location of the data structure or variable. The first address logic pipeline can be used to derive a physical memory address for an entry in a variable given an identification of that entry. For example, the first address logic pipeline could be used to derive a physical memory address for an entry in a tensor given a location of that entry in the tensor. The fast address logic pipeline could be used to derive the same physical memory address as the first address pipeline. The first address output and the fast address output could both be an address for the location in memory.

The fast address logic pipeline can be faster than the first address logic pipeline, at least for situations in which the data structure or variable has a specific dimension or dimensionality. For example, the fast address logic pipeline could be optimized for tensors with dimensions that are a power of two in size. The fast address logic pipeline could either not function or could be slower than the first address logic pipeline in situation in which the data structure or variable did not have that specific dimension or dimensionality. For example, the fast address logic pipeline could fail for tensors with dimensions that were not a power of two in size. The first address logic pipeline could still provide an output address when the dimensions of the data structure or variable were not a power of two in size.

In specific embodiments of the invention, the systems disclosed herein could include a configuration register. The values stored in the configuration register could impact how the logic pipelines disclosed herein operate. For example, the configuration register could store variables whose values impacted the logic executed by the logic pipelines. The configuration register could include a physical memory start address for a given data structure, the dimensions of a given data structure in the data-structure space, and the format of a given data structure. The values in the configuration register could be used to derive physical addresses for entries within the data structure.

In specific embodiments of the invention, the systems disclosed herein can include a first data structure section logic pipeline and a fast data structure section logic pipeline. The data structure section logic pipelines can be programmed to convert a location of a section in a data structure or in a variable (i.e., in the data-structure-space) into a physical address in memory (i.e., in the physical-memory-address-space). The logic pipelines could receive a dimension of the data structure and output a section address output. The first data structure section logic pipeline could output a first data structure section output. The fast data structure section logic pipeline could output a fast data structure section output. The first data structure section output and the fast data structure section output could be a physical address for the same section of the data structure. The logic pipelines could output more than one address where the different addresses corresponded to different sections of the data structure. The first data structure section logic pipeline can be used to derive a physical memory address for a section of a data structure (e.g., the start of an exponent section of the data structure, or the start of a mantissa section of the data structure). For example, the tensor could have a data type that uses exponents and mantissas and the first tile section address output and the fast tile section address output could be addresses for at least one of: an exponent section of the data tile and a mantissa section of the data tile. As another example, the first data structure section logic pipeline could be used to derive a physical memory address for the start of the data of a data structure after the header of the data structure. The fast data structure section logic pipeline could be used to derive the same physical memory address as the first data structure section logic pipeline.

The data structure section logic pipeline can be faster than the first data structure section logic pipeline, at least for situations in which the data structure or variable has a specific dimension or dimensionality. For example, the fast data structure section logic pipeline could be optimized for data structures with dimensions that are a power of two in size. The fast data structure section logic pipeline could either not function or could be slower than the first data structure section logic pipeline in situation in which the data structure did not have that specific dimension or dimensionality. For example, the fast data structure section logic pipeline could fail for data tiles with dimensions that were not a power of two in size or for data tiles that did not store variables with dimensions that were a power of two in size. The first data structure section logic pipeline could still provide an output address when the dimensions of the data structure (e.g., data tile) or the variables stored in the data structure were not a power of two in size.

In specific embodiments of the inventions disclosed herein, the systems could include control logic circuits that adaptively route the outputs of the logic pipelines mentioned above. For example, in specific embodiments, the control circuit could route one and only one of: (i) the first address output for use in finding an address in the memory; and (ii) the fast address output for use in finding the address in the memory. As another example, in specific embodiments, the control circuit could route one and only one of: (i) the first tile section address output for use in finding the address in the memory; and (ii) the fast tile section address output for use in finding the address in the memory.

In specific embodiments, the adaptive routing could be conducted based on the dimensions of the data structure or variable for which an address was being computed. The adaptive routing could be conducted based on a tensor dimension as stored in the configuration register mentioned above where the system was being used to produce a physical address for a tensor having that dimension. The control logic could adaptively route the output of the pipelines based on the tensor dimension being a common dimension. In specific embodiments, the common dimension could be a power of two. The common dimension could be selected because the variables or data structures that the system will be operating on will commonly have a certain dimension such that the combinatorial logic that computes physical addresses can be optimized for variables or data structures having that common dimension. In specific embodiments, the common dimension will be a power of two and the system will be optimized to produce addresses for tensors with dimensions that are a power of two.

In specific embodiments, the control logic mentioned above can include a multiplexer. The multiplexer can have the first address output as one input to the multiplexer and the fast address output as a second input to the multiplexer. Such a multiplexer could have a control signal which indicates that the tensor dimension is a common dimension to be used to select which of the two inputs to route through the multiplexer. For example, if the tensor dimension was the common dimension, the fast address output could be routed through the multiplexer and otherwise the first address output could be routed through. The multiplexer can have the first section address output as one input to the multiplexer and the fast section address output as a second input to the multiplexer. Such a multiplexer could have a control signal which indicates that the tensor dimension is a common dimension to be used to select which of the two inputs to route through the multiplexer. For example, if the tensor dimension was the common dimension, the fast section output could be routed through the multiplexer and otherwise the first section output could be routed through.

In specific embodiments, the system could include the first pipelines mentioned above (i.e., the first address pipeline and the first address section pipeline) and could include one or both of the fast pipelines mentioned above (i.e., one or both of the fast address pipeline and the fast address section pipeline). In these embodiments, the address section output could be another input to the first address pipeline and could also be an input the fast address pipeline if there was a fast address pipeline in the system. In embodiments using both the fast address pipeline and the fast address section pipeline, the system could include two control circuits in accordance with the disclosure above where each adaptively routed either the output of the associated first pipeline or the fast pipeline based on the dimensions of the variable or data structure.

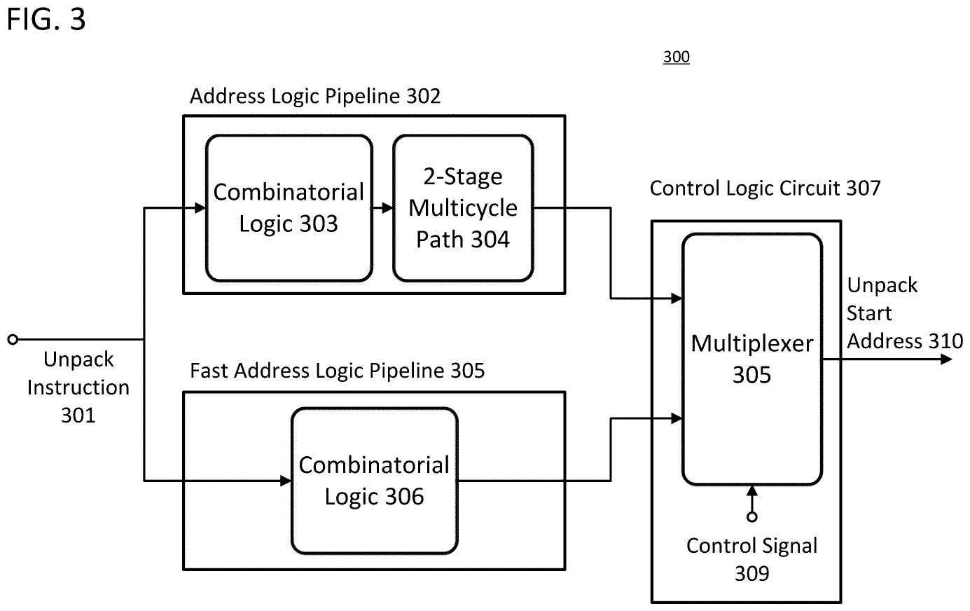

FIG. 3 illustrates a system 300 for producing unpack start address 310 for unpack instruction 301. Unpack instruction 301 can be an instruction that requests data from a data structure to be made available for a computation. Unpack instruction 301 can be provided on an instruction line that is coupled to address logic pipeline 302 and fast address logic pipeline 305. The data can be stored in a compressed format and unpack instruction 301 can result in a decompression of the data. Unpack instruction 301 can identify a location of the required data entries in a data structure. For example, unpack instruction 301 can identify an initial location and a range. More specifically, unpack instruction 301 could identify an address of an entry in a data structure, such as an entry in a data tile, and a number of entries after the addressed entry that should be retrieved and unpacked.

The illustrated address logic pipeline 302 and fast address logic pipeline 305 could each output an address output based on the location of the required data entries from the unpack instruction. Fast address logic pipeline 305 could be optimized for outputting this address when the dimensions of the data structure or variable are a common dimension. For example, fast address logic pipeline 305 could be optimized for generating the output address when the dimensions of a tensor that is the subject of the unpack instruction is a power of two. Fast address logic pipeline 305 could be faster than address logic pipeline 302 in such situations. Address logic pipeline 302 may include combinatorial logic 303 and 2-stage multicycle path 304. Fast address logic pipeline 305 may include combinatorial logic 306, which may be optimized for outputting an address when the dimensions of the data structure or variable are a common dimension.

Control logic circuit 307 could be configured to adaptively route one of the address outputs from the two pipelines as unpack start address 310 using control signal 309 and multiplexer 308. Control signal 309 could indicate if the dimensions of the data structure or variable were a common dimension. For example, the common dimension could be a power of two. If control signal 309 indicated the dimension of the data structure or variable was that common dimension, control logic circuit 307 could route the output of fast address logic pipeline 305 as the output of the control logic circuit 307. Otherwise, control logic circuit 307 could route the output of first address logic pipeline 302.

A section address may be required to find the data structure or a section of the data structure in memory. In specific embodiments, unpack instruction 301 could provide the section of the data structure. In specific embodiments, the section address of the data structure may be derived from information held in a configuration register and could be delivered to system 300.

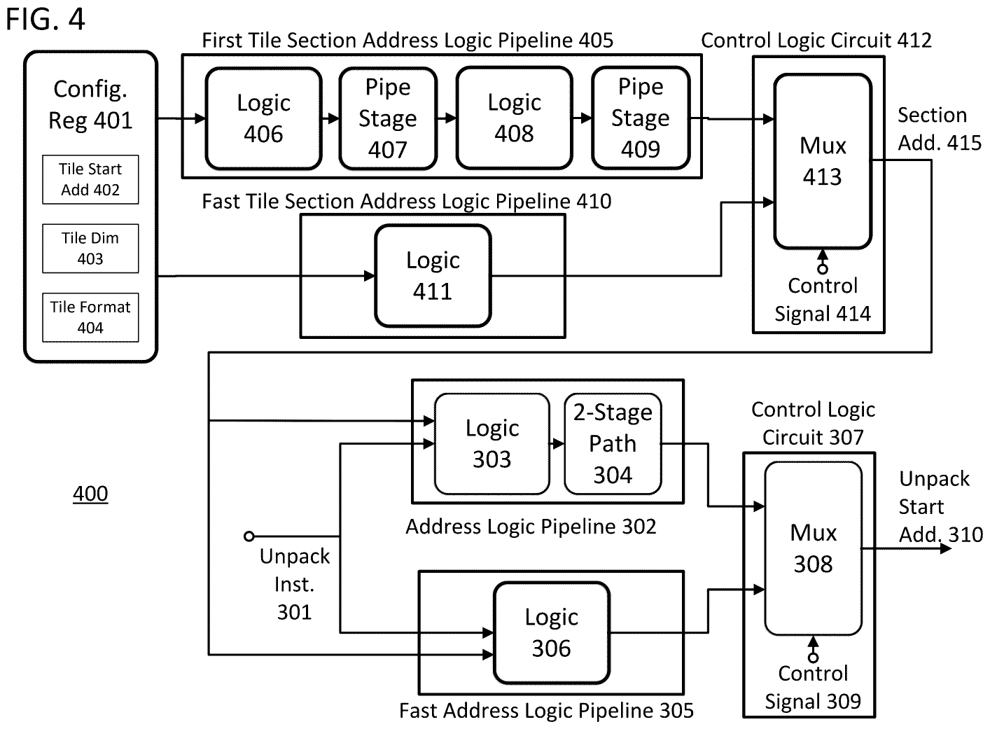

FIG. 4 illustrates a more complex system 400 for producing an unpack start address for an unpack instruction in accordance with specific embodiments of the inventions disclosed herein. System 400 in FIG. 4 includes system 300 of FIG. 3 as a subblock and additionally includes control logic circuit 412, first tile section address logic pipeline 405, and fast tile section address logic pipeline 410. First tile section address logic pipeline 405 includes logic 406, first pipe stage 407, logic 408, and second pipe stage 409. Fast tile section address logic pipeline 410 includes logic 411. In the illustrated system 400, unpack instruction 301 could provide the location of an entry within a data structure, and additional information may be required to find the data structure or a section of the data structure in memory. That additional information could be a section address which is delivered to the system of FIG. 3.

The manner in which the section address is produced in FIG. 3 is similar to the manner in which the physical address is produced in FIG. 4. However, the section address is derived from information held in a configuration register as opposed to as provided in an unpack instructions. FIG. 4 includes both first tile section address logic pipeline 405 and fast tile section address logic pipeline 410. Both pipelines may be configured to produce one or more section addresses based on the information in configuration register 401. For example, configuration register 401 could identify the data structure format 404 that the data structure (e.g., tile) was stored in, the dimensions 403 of the data structure, and the start address 402 of the data structure in memory. From that, the start address (e.g., section address 415) for certain sections of the data structure could be derived. Similarly to FIG. 3, the two pipelines could both produce the same one or more section addresses while fast tile section address logic pipeline 410 may be optimized for doing such a computation when the dimensions 403 of the tile were a common dimension. For example, when the dimensions 403 of the tile were a power of two. Fast tile section address logic pipeline 410 could either produce an incorrect result or be slower than first tile section address logic pipeline 405 when the tile dimensions 403 were not the common dimension.

As illustrated, control logic circuit 412 could include multiplexer 413 that would route the output of fast tile section address logic pipeline 410 as section address 415 when control signal 414 indicated that the tile had the common dimension and otherwise route the output of first tile section address logic pipeline 405 as section address 415. In these embodiments, the tile dimension value in configuration register 401 could also be used to produce the control signals for either one or both of the control logic circuits (e.g., control signals 414 and 309).

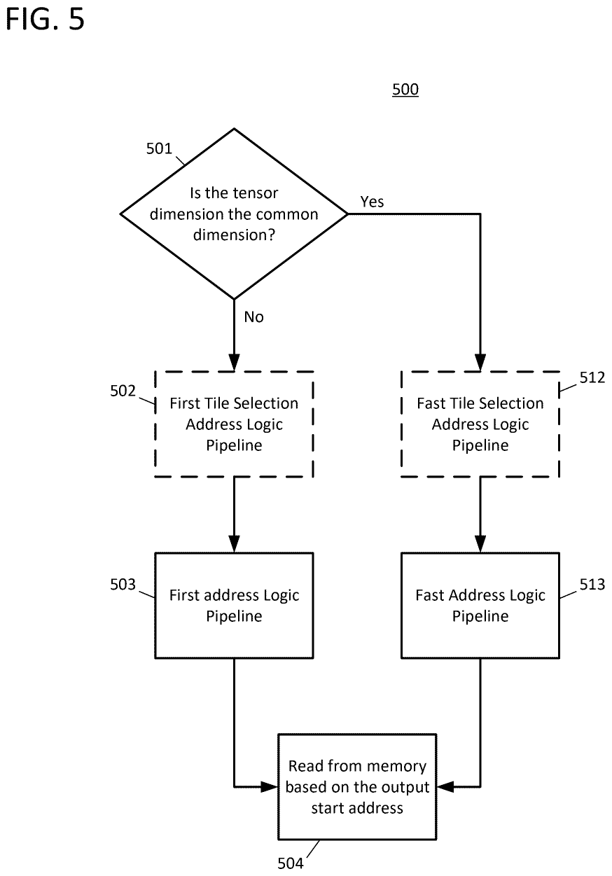

FIG. 5 illustrates flowchart 500 for determining and reading from a memory address in accordance with specific embodiments of the inventions disclosed herein. Flowchart 500 may be performed by a system such as system 300 or 400. In specific embodiments, steps such as steps 502 and 512 may be skipped. Flowchart 500 may be repeated for different data structures, variables, access requests, or unpack instructions. Both the first tile selection address logic pipeline and the fast tile selection address logic pipeline may be configured to produce one or more section start addresses based on the information in the configuration register. Both the first address logic pipeline and the fast address logic pipeline may be configured to output one or more addresses based on the location of the required data entries from an unpack instruction.

At step 501, whether the tensor dimension (or the tile dimension) is the common dimension may be determined. A configuration register could identify the dimensions of the tensor (or the tile). This determination may be used as control signals to one or more multiplexers. In specific embodiments, a tile header may include the tile dimension. If the tensor dimension (or the tile dimension) is the common dimension (e.g., a power of two), then the process may proceed to step 512. If the tensor dimension is not the common dimension, the process may proceed to step 502. Both step 502 and step 512 may be configured to produce one or more section start addresses based on the information in the configuration register.

At step 502, the first tile selection address logic pipeline may process information from the configuration register to determine a section start address.

At step 503, the first address logic pipeline may output an address output based on the location of the required data entries from the unpack instruction and the section start address from the first tile selection address logic pipeline from step 502.

At step 512, the fast tile selection address logic pipeline may process information from the configuration register to determine a section start address. The fast tile section address logic pipeline may be optimized for doing such a computation (e.g., faster than first tile selection address logic pipeline) when the dimensions of the tensor (or the tile) are a common dimension. If the tensor dimensions are not the common dimension, then fast tile section address logic pipeline could either produce an incorrect result or be slower than the first tile section address logic pipeline.

At step 513, the fast address logic pipeline may output an address output based on the location of the required data entries from the unpack instruction and the section start address from the fast tile selection address logic pipeline from step 512. The fast address logic pipeline could be optimized for (e.g., faster than the address logic pipeline) outputting this address when the dimensions of the data structure or variable are a common dimension. If the tensor dimensions are not the common dimension, then fast address logic pipeline could either produce an incorrect result or be slower than the first address logic pipeline.

At step 504, the memory may be read (e.g., unpacked) based on the output start address of either step 503 or step 513. Both the output address from the first address logic pipeline at step 503 and the output address from the fast address logic pipeline from step 513 may be the same output address. If the tensor dimension is the common dimension, then steps 512 and 513 may execute faster than steps 502 and 503 respectively. If the tensor dimension is not the common dimension, then steps 512 and 513 may execute slower than steps 502 and 503 respectively, or may be incorrect.

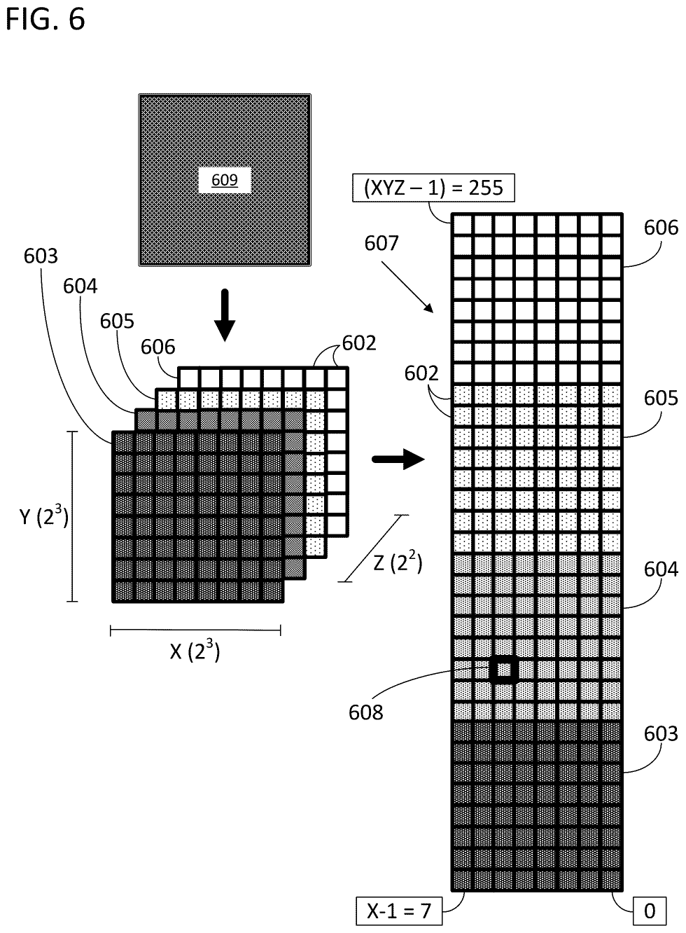

FIG. 6 provides an illustration of tensor 609 with dimensions that are powers of two in accordance with specific embodiments disclosed herein. Entries 602 of tensor 609 may have a floating-point data type such that each entry 602 includes a mantissa and an exponent. A computational system may include different levels of referring to data such as the variable-level, the data structure-level (e.g., tile-level), and memory address-level. The memory-address-level can utilize physical memory addresses which refer to specific physical addresses at which data elements are stored. The data structure-level can utilize data structure entry addresses which refer to specific data entries within the data structure. The variable-level can utilize variable entry addresses which refer to specific entries of the variable (e.g., specific entries in a matrix).

FIG. 6 illustrates tensor 609 which is at the variable-level of the computational system. Tensor 609 could be an input tensor to a layer in a CNN which will be used in a convolution operation during the execution of a directed graph to which it is a part. In the illustrated case, tensor 609 is a three-dimensional tensor with (x, y, z) dimensions of (2³, 2³, 2²) and can be represented by 4 (“z”) two-dimensional matrices 603-606 where each matrix 603, 604, 605, and 606 has dimensions 8×8 (“x” by “y”). Although the example of FIG. 6 uses a three-dimensional tensor, tensors with higher-level dimensions (e.g., with domains that are orders of magnitude larger than three) may be used. Additionally, the X and Y numbers could each range into the millions or billions.

The squares in matrices 603-606 represent individual entries 602 in tensor 609 which can be stored as individual data elements in a data structure and can be independently addressed in a memory. The values could be represented in memory using data elements with specific data types and precision levels (e.g., 16-b floating point). The individual data values of the tensor can be addressed using a standard cartesian coordinate system. For a three-dimensional tensor, the coordinates would be (x, y, z) with x ranging from 0 to X−1, y ranging from 0 to Y−1, and z ranging from 0 to Z−1. In the example of tensor 609 with (X, Y, Z) dimensions of (8, 8, 4), the coordinates (x, y, z) are such that x ranges from 0 to 7, y ranges from 0 to 7, and z ranges from 0 to 3.

FIG. 6 provides an illustration of translating three-dimensional tensor 609 (e.g., at the variable-level space) into the address space of a two-dimensional physical or virtual memory (e.g., at the memory address-level space). The process may be visually represented by laying the four matrices 603, 604, 605, and 606 (the z-planes of tensor 609) end-to-head as shown in view 607 and addressing them row-by-row from bottom to top; and right to left. Obtaining an address of a data element in the memory-address-space given an address of the data element in the graph-space involves the translation: Address (x, y, z)=x+X*y+X*Y*z. Where “X”, “Y”, and “Z” are the size of the domains of the three-dimensions of the tensor, and (x, y, z) are the coordinates of the data element in the graph-space. In the example of tensor 609, the equation for a data element is: Address (x, y, z)=x+y(2³)+z(2³)(2³)=x+y(2³)+z(2⁶). Using this equation, a translation can be found between the variable-level and memory address-level of the system. For example, the last data entry would be (7, 7, 3) and would correspond to 7+7(2³)+3(2⁶), equating to address 255. Another way to calculate the address for the last data entry is (XYZ−1)=255. As another example, data element 608 is located at (5, 2, 1) and the corresponding address is 5+2(2³)+1(2⁶)=85. These addresses (e.g., address 255 and address 85) may refer to offsets. That is, determining the physical memory address of an entry in a tensor may include a first computation to find the starting physical memory address for a data structure (e.g., tile) or portion thereof, and then a second computation to find the offset for the specific entry in the tensor.

The translation from the variable-level to the memory address-level of the system can be used to obtain specific data from tensor 609 when executing the directed graph to which tensor 609 is a part. The translation can be the first step in conducting a random access of data in tensor 609. The fast address logic pipeline disclosed herein can be tasked with converting a location in the variable-level or data-structure-level (e.g., data tile level) into an address at the memory-level when the tensor dimensions are powers of 2. For example, the fast address logic pipeline can take in an address of an entry 602 in tensor 609 and provide a physical memory address for that tensor 609 in a memory. To translate all the way from the variable-level to the memory-level, the system may need to know where the data structures (e.g., tiles) are stored in memory and which variables are stored in which data structures. Determining the physical memory address of an entry 602 in tensor 609 can thereby include a first computation to find the physical memory address for a data structure (e.g., tile) or portion thereof, and then a second computation to find the offset for the specific entry 602 in tensor 609. The fast address logic pipeline may be optimized for computations using powers of two. For example, the fast address logic pipeline may be optimized to execute Address=x+y(2^{a})+z(2^{a+b}). Where 2^{a} is the X of the tensor, 2^{b} is the Y dimension of the tensor, and 2^{c} is the Z dimension of the tensor; a, b, and c are integers; and (x, y, z) is the variable-space location of the specific entry to be read. The operation of accessing and decompressing data entries in a given tensor could be specified by an unpack instruction.

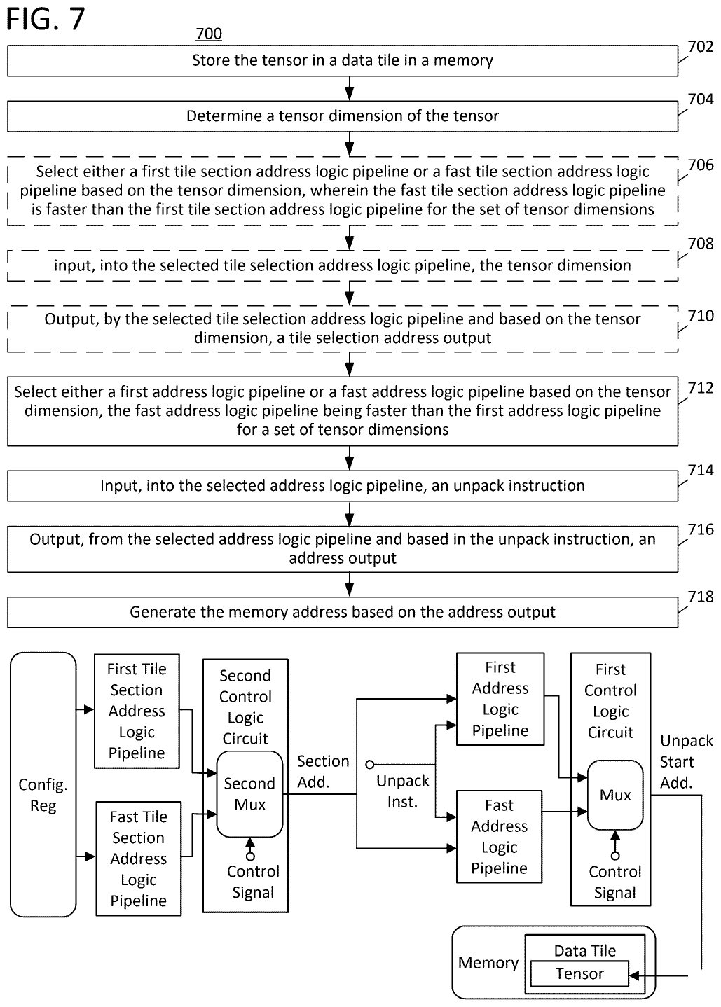

FIG. 7 illustrates an example of method 700 for generating a memory address for a tensor in accordance with specific embodiments of the inventions disclosed herein. Method 700 may be implemented by a system including an instruction line, a first address logic pipeline, a fast address logic pipeline, and a control logic circuit. In specific embodiments, the system may also include a configuration register, a first tile section address logic pipeline, a fast tile section address logic pipeline, and a second control logic circuit. Method 700 may be implemented by a system including means for performing the steps of method 700. Steps, or portions of steps, of method 700 may be duplicated, omitted, rearranged, or otherwise deviate from the form shown. Additional steps may be added to method 700. Steps, or portions of steps, of method 700 may be performed in series or parallel.

At step 702, the tensor may be stored in a data tile in a memory. The memory may be a random-access memory. In specific embodiments, the tensor has a data type with a first part and a second part. In specific embodiments, the tensor has a data type that uses exponents and mantissas.

At step 704, a tensor dimension of the tensor may be determined. In specific embodiments, a configuration register may store the tensor dimension.

In specific embodiments, at step 706, either a first tile section address logic pipeline or a fast tile section address logic pipeline may be selected based on the tensor dimension (e.g., determined at step 704). The fast tile section address logic pipeline may be faster than the first tile section address logic pipeline for a set of tensor dimensions. The set of tensor dimensions may be a set of common dimension (e.g., dimensions of powers of two).

In specific embodiments, at step 708, the tensor dimension may be input into the selected tile selection address logic pipeline. In specific embodiments, the tensor dimension may be input into (e.g., and processed by) both the first tile selection address logic pipeline and the fast tile selection address pipeline, but only the selected pipeline output may proceed in the method while the other is discarded.

In specific embodiments, at step 710, a tile selection address output may be output by the selected tile selection address logic pipeline based on the tensor dimension. In specific embodiments, a tile selection address output from the first tile selection address pipeline and a tile selection address output from the fast tile selection address pipeline would be the same;

however, the tile selection address output from the fast tile selection address logic pipeline may be generated faster than the tile selection address output from the first tile selection address logic pipeline if the tensor dimension is part of the set of tensor dimensions. Second control logic may be programmed to route one and only one of the first tile section address output and the fast tile section address output based on the tensor dimension. The tensor dimension may be stored in the configuration register. In specific embodiments, the tensor has a data type with a first part and a second part; the tile section address output may be an address for a first section (e.g., an exponent section) of the data tile for the first part and/or a second section (e.g., a mantissa section) of the data tile for the second part. In specific embodiments, second control logic may include a multiplexer; a tile section address output from the first tile section address pipeline may be one input to the multiplexer and a tile section address output from the fast tile section address pipeline may be a second input to the multiplexer. A control signal of the multiplexer may be a signal indicating the tensor dimension is in the set of tensor dimensions (e.g., is a common dimension).

At step 712, either a first address logic pipeline or a fast address logic pipeline may be selected based on the tensor dimension. The fast address logic pipeline may be faster than the first address logic pipeline for the set of tensor dimensions. The set of tensor dimensions may be a set of common dimension (e.g., dimensions of powers of two).

At step 714, an unpack instruction may be input into the selected address logic pipeline. In specific embodiments, the unpack instruction may be input into (e.g., and processed by) both the first address logic pipeline and the fast address logic pipeline, but only the selected pipeline output may proceed in the method while the other is discarded.

At step 716, an address output may be output from the selected address logic pipeline based in the unpack instruction. In specific embodiments, an address output from the first address pipeline and an address output from the fast address pipeline would be the same; however, the address output from the fast address logic pipeline may be generated faster than the address output from the first address logic pipeline if the tensor dimension is part of the set of tensor dimensions. In specific embodiments, first control logic may be programmed to route one and only one of a first address output of the first address logic pipeline and a fast address output of the fast address logic pipeline based on the tensor dimension. In specific embodiments, the tensor dimension may be stored in the configuration register. In specific embodiments, the first control logic circuit may include a multiplexer; the first address output may be one input to the multiplexer; and the fast address output is a second input to the multiplexer. A control signal of the multiplexer may be a signal indicating the tensor dimension is in the set of tensor dimensions (e.g., is a common dimension).

At step 718, the memory address may be generated based on the address output. In specific embodiments, generating the memory address may also be based on the tile selection address output (e.g., output at step 710). By adaptively selecting between outputs from standard and fast logic pipelines based on tensor dimensions, the system is able to optimized performance for common cases while also efficiently handling tensors with varying dimensions.

As disclosed herein, the term “programmed to” when used with reference to combinatorial logic, logic circuits, or any pipeline refers to the fact that the system has been designed to execute certain functions and does not mean to include that the system is capable of executing source code. For example, as used herein, a standard AND gate is “programmed” to produce a logical “AND” value from a set of inputs that are provided as inputs.

While the specification has been described in detail with respect to specific embodiments of the invention, it will be appreciated that those skilled in the art, upon attaining an understanding of the foregoing, may readily conceive of alterations to, variations of, and equivalents to these embodiments. For example, the example of a data tile was disclosed herein as an example of a data structure. However, similar approaches can be applied for other data structures such as relationally stored databases and other data structures. Accordingly, the tile section address logic pipeline and fast tile section address logic pipelines could be more broadly referred to as data structure section address logic pipelines. As another example, the example of a tensor was disclosed herein as an example of a variable from which entries are required for a computation. However, similar approaches can be applied to variables in the form of vectors, matrixes, arrays, linked lists, or trees. These and other modifications and variations to the present invention may be practiced by those skilled in the art, without departing from the scope of the present invention, which is more particularly set forth in the appended claims.

What is claimed is:

1. A system for generating a memory address for a tensor stored in a memory, wherein the
tensor is stored in a data tile in the memory, comprising:
an instruction line with an unpack instruction, the unpack instruction identifying a location in the tensor;
a first address logic pipeline that is coupled to the instruction line and that outputs a first address output;
a fast address logic pipeline that is coupled to the instruction line and that outputs a fast address output, the fast address logic pipeline being faster than the first address logic pipeline; and
a control logic circuit that routes one and only one of: (i) the first address output to be used as the memory address to access the tensor in the memory; and (ii) the fast address output to be used as the memory address to access the tensor in the memory.

2. The system of claim 1, wherein:
the first address output and the fast address output are the same.

3. The system of claim 1, further comprising:
a configuration register storing a tensor dimension for the tensor;
wherein the control logic is programmed to route one and only one of the first address output and the fast address output based on the tensor dimension as stored in the configuration register.

4. The system of claim 3, wherein:
the control logic circuit includes a multiplexer;
the first address output is one input to the multiplexer;
the fast address output is a second input to the multiplexer;
a control signal of the multiplexer is a signal indicating the tensor dimension is a common dimension; and
the fast address logic pipeline is optimized for tensors having the common dimension.

5. The system of claim 3, wherein:
the control logic circuit includes a multiplexer;
the first address output is one input to the multiplexer;
the fast address output is a second input to the multiplexer; and
a control signal of the multiplexer is a signal indicating the tensor dimension is a power of two.

6. The system of claim 1, wherein:
the control logic circuit is programmed to route one and only one of the first address output and the fast address output based on a tensor dimension of the tensor.

7. The system of claim 1, further comprising:
a configuration register storing a tensor dimension for the tensor;
a first tile section address logic pipeline that receives the tensor dimension and outputs a first tile section address output;
a fast tile section address logic pipeline that receives the tensor dimension and outputs a fast tile section address output, wherein the fast tile section address logic pipeline is faster than the first tile section address logic pipeline; and
a second control logic circuit that routes one and only one of: (i) the first tile section address output for use in finding the memory address in the memory; and (ii) the fast tile section address output for use in finding the memory address in the memory.

8. The system of claim 7, wherein:
the second control logic is programmed to route one and only one of the first tile section address output and the fast tile section address output based on the tensor dimension as stored in the configuration register; and
the control logic is programmed to route one and only one of the first address output and the fast address output based on the tensor dimension as stored in the configuration register.

9. The system of claim 8, wherein:
the tensor has a data type with a first part and a second part; and
the first tile section address output and the fast tile section address output are addresses for at least one of: (i) a first section of the data tile for the first part; and (ii) a second section of the data tile for the second part.

10. The system of claim 8, wherein:
the tensor has a data type that uses exponents and mantissas; and
the first tile section address output and the fast tile section address output are addresses for at least one of: (i) an exponent section of the data tile; and (ii) a mantissa section of the data tile.

11. The system of claim 8, wherein:
the second control logic includes a multiplexer;
the first tile section address output is one input to the multiplexer;
the fast tile section address output is a second input to the multiplexer;
a control signal of the multiplexer is a signal indicating the tensor dimension is a common dimension; and
the fast tile section address logic pipeline is optimized to operate on tensor dimensions having the common dimension.

12. The system of claim 8, wherein:
the second control logic includes a multiplexer;
the first tile section address output is one input to the multiplexer;
the fast tile section address output is a second input to the multiplexer; and
a control signal of the multiplexer is a signal indicating the tensor dimension is a power of two.

13. A system for generating a memory address for a tensor stored in a memory, wherein the tensor is stored in a data tile in the memory, comprising:
a configuration register storing a tensor dimension;
a first tile section address logic pipeline that receives the tensor dimension and outputs a first tile section address output based on the tensor dimension;
a fast tile section address logic pipeline that receives the tensor dimension and outputs a fast tile section address output, the fast tile section address logic pipeline being faster than the first tile section address logic pipeline; and
a control logic circuit that routes one and only one of: (i) the first tile section address output for use in generating the memory address; and (ii) the fast tile section address output for use in generating the memory address.

14. The system of claim 13, wherein:
the control logic circuit is programmed to route one and only one of the first tile section address output and the fast tile section address output based on the tensor dimension as stored in the configuration register.

15. The system of claim 13, wherein:
the tensor has a data type with a first part and a second part; and
the first tile section address output and the fast tile section address output are addresses for at least one of: (i) a first section of the data tile for the first part; and (ii) a second section of the data tile for the second part.

16. The system of claim 13, wherein:
the tensor has a data type that uses exponents and mantissas; and
the first tile section address output and the fast tile section address output are addresses for at least one of: (i) an exponent section of the data tile; and (ii) a mantissa section of the data tile.

17. The system of claim 13, wherein:
the control logic circuit includes a multiplexer;
the first tile section address output is one input to the multiplexer;
the fast tile section address output is a second input to the multiplexer;
a control signal of the multiplexer is a signal indicating the tensor dimension is a common dimension; and
the fast tile section address logic pipeline is optimized to operate on tensor dimensions having the common dimension.

18. The system of claim 13, wherein:
the control logic includes a multiplexer;
the first tile section address output is one input to the multiplexer;
the fast tile section address output is a second input to the multiplexer; and
a control signal of the multiplexer is a signal indicating the tensor dimension is a power of two.

19. A method for generating a memory address for a tensor, comprising:
storing the tensor in a data tile in a memory;
determining a tensor dimension of the tensor;
selecting either a first address logic pipeline or a fast address logic pipeline based on the tensor dimension, the fast address logic pipeline being faster than the first address logic pipeline for a set of tensor dimensions;
inputting, into the selected address logic pipeline, an unpack instruction;
outputting, from the selected address logic pipeline and based in the unpack instruction, an address output; and
generating the memory address based on the address output.

20. The method of claim 19, further comprising:
selecting either a first tile section address logic pipeline or a fast tile section address logic pipeline based on the tensor dimension, wherein the fast tile section address logic pipeline is faster than the first tile section address logic pipeline for the set of tensor dimensions;
inputting, into the selected tile selection address logic pipeline, the tensor dimension; and
outputting, by the selected tile selection address logic pipeline and based on the tensor dimension, a tile selection address output;
wherein generating the memory address is based on the tile selection address output.
